(19) United States
(12) Patent Application Publication
(10) Pub. No.: US 2004/0069853 A1
(43) Pub. Date: Apr. 15, 2004

(54) Smart card having an optical communication circuit and a method for use thereof

(76) Inventor: Dov Aharonson, Herzlia (IL)

Correspondence Address: NATH & ASSOCIATES, 1030 15th STREET, 6TH FLOOR, WASHINGTON, DC, 20005, US

(21) Appl. No.: 10/468,000

(22) PCT Filed: Feb. 14, 2002
(86) PCT No.: PCT/IL02/00115

(30) Foreign Application Priority Data
Feb. 15, 2001 (IL) 141441

(51) Int. Cl. G06K 7/10; G06K 7/14

(52) U.S. Cl. 235/454

(57) ABSTRACT

A system for carrying out a secure transaction between a data transaction device and a client machine, wherein the data transaction device includes at least one optical sensor for receiving from an application a light beam modulated with data that informs a user of the data transaction device of a return code for sending to the client machine in order to complete the transaction. The client machine includes a modulator for modulating a signal representative of a light beam with data associated with a transaction code so as to form a modulated light beam signal, and a display driver coupled to the modulator and responsive to the modulated light beam signal for illuminating a display device so that at least some pixels thereof emit a light beam that is modulated with the data. A verification unit verifies a return code issued by a user of the data transaction device, and a transaction processor is coupled to the verification unit for processing the transaction in accordance with the transaction code if the return code matches the transaction code or a function thereof.

### FIELD OF THE INVENTION

This invention relates to secure data transactions in general and, in particular, to the use of smart cards for carrying them out.

### BACKGROUND OF THE INVENTION

Smart Cards are increasingly being used to provide owners and service providers with an expanding range of applications such as electronic purse, parking, Internet transactions, as well as providing access to a wide range of standalone services such as vending machines, arcade games, information services and so on. To this end, smart cards are provided with some sort of communications interface for allowing communication between the smart card and an external application. Typically, the communications interface is constituted by contacts conforming to ISO 7816 or by a coil antenna that allows for non-contact communication in accordance with ISO 14443, for example, by means of inductive coupling with a like coil antenna in a fixed station associated with the application.

Most high security applications prohibit contactless data transfer owing to the risk of eavesdropping and thus insist on communication via contacts on the smart card effecting contact with complementary contacts in the card reader. It is usual for the card reader to both read data from the smart card and to write data thereto. Such high security applications include electronic purses where the smart card serves as a reservoir of virtual cash that may be used to purchase commodities in much the same way that credit cards are used, except that they effect an immediate cash transfer to the vendor.

Regardless of whether data is transferred between the reader and the smart card using the contact pad or the coil antenna, the reader itself is a customized unit that is hardly likely, at least in its present form, to find entry into domestic premises. Since at some stage during use of smart cards access to the reader is required, this imposes the requirement that the end-user currently is constrained to take his or her smart card to the card reader. Consider, for example, the use of a smart card as an electronic purse. Periodically, credit must be loaded in the smart card, this being debited as when the smart card is used as a source of virtual cash. The loading of credit is typically carried out using an Automatic Teller Machine (ATM) associated with the user's bank so that his or her bank account can be debited by an amount of cash to be transferred to the electronic purse. This means that a user finding himself without cash and with insufficient credit in his electronic purse must first locate the nearest ATM before use of the electronic purse can even be contemplated. This is clearly inconvenient and imposes a hardship on the user.

This is but typical of Smart Card applications where the communications interface acts a significant barrier to widespread use thereof. It would clearly be beneficial if communication between the smart card and a service provider could be effected without the need for a special card reader for interacting with the Smart Card. In particular, since most homes now have access to a personal computer, it would represent a major convenience to the homeowner if the personal computer could serve as the card reader. Current approaches to providing such facility require auxiliary equipment, such as magnetic card readers connected to the computer. It would therefore be desirable to allow a personal computer to serve as a smart card interface without the need for such auxiliary equipment.

Some of these issues have been addressed in the art. Thus, for example, U.S. Pat. No. 5,789,733 entitled “Smart card with contactless optical interface” discloses an optical smart card including a microchip having information stored thereon, and an optical holographic sensor pad for receiving light beams emitted from a remote reader/transmitter. A light source emits electronic data contained in the microchip back to the remote reader/transmitter.

This reference appears not to deal with the case where a passive light source is used, such as an LCD, which requires light to be reflected therefrom for the displayed data to be rendered visible. Moreover, the card requires a special optical pick-up to read the TV signal.

U.S. Pat. No. 5,594,493 (Nemirofsky) entitled “Television signal activated interactive smart card system” describes a smart card which includes an optical receiver for receiving promotion data encoded in a television signal and transmitted through a cathode ray tube of a television. The smart card also includes circuitry for storing the promotion data and circuitry for executing the promotions associated with the promotion data, including circuitry for displaying a promotion in the form of a UPC code on an LCD display. The smart card further includes circuitry for interacting with a user through the LCD display and a keypad.

The smart card is equipped with a photoelectric television signal optical pickup device comprising a plastic sleeve and lens to pickup the light from the TV set. In use, the card is held facing and near the TV screen. There is no suggestion to place the card on the screen for reading specific area on it. Moreover, since the device operates using transmitted light, it is not suited to data communication with a LCD display, where the light is reflected.

U.S. Pat. No. 5,953,047 (Nemirofsky) entitled “Television signal activated interactive smart card system” allows a smart card to be used in conjunction with a television set and a bar code and/or light scan reader for allowing data to be transmitted by the TV, picked up and stored by the smart card and converted into signals that are readable by the bar code and/or light scan reader. The smart card is adapted to read and record signals from a scanned cathode ray tube such as a television receiver. The signal may be transmitted to the television receiver as part of a conventional transmission from a television station and may include an encoded signal of pulsed light displayed by the television receiver. The light pulses are not visible to a person watching the television receiver, but may be read by the smart card by holding it up to the television receiver while the signal is being displayed.

A particular application of such an arrangement is to allow promotion data encoded in a television signal and transmitted through a cathode ray tube thereof to be picked up and stored by a smart card. The smart card also includes circuitry for executing the promotions associated with the promotion data, including circuitry for displaying a promotion in the form of a UPC code on an LCD display of the smart card.

In such an arrangement, the data that is communicated to the smart card by the TV set is public promotional material that allows a promotional transaction to be initiated by the card or user using a modem or barcode or light reader devices. There is no suggestion to transmit sensitive and personal data to the smart card owner for allowing her to initiate a confidential transaction, receive a unique transaction code through the TV display to the card, and have the card reveal the transaction code only if the transaction is valid to the owner so as to allow her to input the transaction code to the system for transaction authorization.

U.S. Pat. No. 5,880,769 entitled “Interactive smart card system for integrating the provision of remote and local services” discloses a smart card including optics for receiving information from a television channel and a modem for providing real-time two way communication with a remote service provider. To maintain system security, data that is provided to the card may be encrypted. Various smart card applications allow use of the smart card for remote financial services, near video-on-demand with automated order and billing, pay-per-view with automated order and billing, appointment TV, home shopping, real-time market studies and opinion polls and electronic gaming and sweepstakes.

Here, too, data is transmitted from the display by means modulating the light emitted by the display with the data, and there is no provision for handling an LCD display, which must be illuminated in order to reflect light to the reader. Moreover, the card requires an integral communications interface for allowing communication between the card and a remote service provider. A telephone number is extracted from the received information and is used by the card to directly interface and call the service provider. All cards active at certain time receive the same, public, information i.e. the service provider's telephone number, and they all use the same information to call the provider in order to initiate a transaction. No provision is made to enable each user to initiate a private transaction and receive his own secured unique transaction number from the transaction server to be used for authorizing the transaction by feeding back the transaction number or some function thereof

U.S. Pat. No. 5,953,047 (Nemirofsky) published Sep. 14, 1999 and entitled “Television signal activated interactive smart card system” discloses a system for transmitting an value/benefit including a recordable product identification and offer of value, for recording the product identification and value and for reading the product identification and value at a point of purchase location and/or benefit redemption venue.

As explained in column 6 lines 43-47 thereof U.S. Pat. No. 5,953,047 uses technology that produces a line-by-line brightness modulation, the resulting signal being invisible to humans, but easily detected by the TV-Card, which detects changes of line intensity between successive transmitted lines during the same refresh cycle of the display, these changes being invisible to the viewer. All of the pixels in each scan line are subjected to the same modification but the pixels in different scan lines are subjected to a different modification.

During each refresh of the display there may be transmitted multiple data bits up to the number of display scan-lines. But this requires one of two approaches for ensuring synchronization: either the transmitted information is pre-recorded (as is done with TV-video) and synchronized with the video scan-lines; or, if transmitting interactively (such as adding information to the PC display), the signals must be synchronized in real time with the PC hardware refresh which may require a special hardware or very specific software driver per each type of display controller.

Such a method requires the provision of a custom device for TV coupon handling including picking the coupon information from the TV and using it at the point of sale. In “algorithmic” terms, this requires transmission of a public message (one source to many targets).

WO 0021020 to Comsense Technologies, Ltd. published Apr. 13, 2000 and entitled “Card for interaction with a computer” describes an optical card comprising optical data input and wireless transmission output A one- or two-dimensional optical input is used which implies the use of methods similar to that described in U.S. Pat. No. 5,953,047 by encoding information along scan-line (one dimension) or on several scan-lines (two dimensions) which again require custom synchronzation.

There is likewise no suggestion to display on the smart card a unique authorization code, which is displayed only if the bearer of the smart card is the authorized owner and is authorized to carry out the requested transaction.

It would therefore be an advantage to provide a smart card having a more flexible optical communications interface that allows coupling with a TV screen and with other display devices, such as LCDs which rely on reflected light rather than transmitted light for displaying data.

Moreover, so far as can be determined the above-mentioned references do not relate to the problems associated with modulating pixels of a display device for communicating data serially to a smart card in a manner that is independent of the refresh rate of the display device or the controlling'software. This is far from a trial problem because proper synchronization between the smart card reader and the display device is subject to the following problems:

(a) variations in the refresh frequencies of different display devices;

(b) the data pulse of a specific pixel on the display is only part of the duty-cycle. Specifically, the duty-cycle is only approximately 20% since although each pixel in a high resolution display device is actually illuminated during very much less than even this nominally low duty-cycle, once “illuminated” it continues to phosphoresce;

(c) synchronization is not possible between the computer software, which writes the serial information to the display device and the refresh mechanism of the display. Moreover the software may not have the ability to update data on the display at the exact frequency as the display refresh rate or even know this exact rate. This may cause the same data bit to produce more than one pulse on the display in the case that it is wider than the period of the display's refresh and may even produce state transition in the middle of the display pulse in an unpredictable manner;

(d) it is not a simple matter to ensue that the software driver in the transmitter responds at the precise frequency that data is written to the display. In fact it is expected that the computer operating system may postpone the driver operations from time to time causing it to skip one or more “clocks” (refresh cycles);

(e) the receiver must be able to analyze the pulses read from the display and extract “0” and “1” data bits, decide when a pulse belongs to a new data bit and when it is produced by overlapping of the last data bit over multiple display refresh cycles owing to delay in the response of the transmitter software.

### SUMMARY OF THE INVENTION

It is therefore an object of the invention to provide a smart card having a more flexible optical communications interface, allowing coupling with a TV screen and with other display devices. A further object of the invention is to allow such a smart card to be used to carry out private and personal transactions, so at allow personal authorization data to modulate visible light that is conveyed via a display device to the smart card and is rendered visible by the smart card only if the bearer is the authorized owner.

To this end there is provided in accordance with a first aspect of the invention a method for communicating data to a data transaction device having at least one optical sensor having at least two communication channels, the method comprising the steps of:

(a) displaying on at least one predetermined window of a display device at least one light beam that is modulated with said data so as to produce at least two independent communication channels by modification of at least two distinguishable features of the at least one light beam in the at least one window and which cooperate to provide timing information such that said at least one light beam is modulated by modifying an intensity and/or color of each pixel within each of said windows and such that all pixels within each of said windows are subjected to identical modification, and

(b) placing an identifiable area of the data transaction device containing the at least one optical sensor so as to overlap the at least one predetermined window of the display device so as to allow extraction of said timing information together with the at least two distinguishable features of the at least one light beam in respective ones of said communication channels.

According to a second aspect of the invention there is provided a method for carrying out a secure transaction between a data transaction device and a client machine coupled to a display device, including the following steps all carried out by the data transaction device or an owner thereof:

(a) inputting a request for service to the client machine,

(b) receiving data from the client machine and conveying transaction data representative thereof via at least two communication channels for conveying separately at least two modulated features of at least one light beam modulated with said data and which cooperate to provide timing information such that the at least one light beam is modulated by modifying an intensity and/or color of each pixel within at least one window of the display device and such that all pixels within the at least one window are subjected to identical modification, and

(c) displaying a transaction code representative of the transaction data on a display unit of the data transaction device.

According to a third aspect of the invention there is provided a method for carrying out a secure transaction between a data transaction device and a client machine, including the following steps all carried out by the client machine:

(a) receiving a request for service,

(b) conveying data to an optical sensor of the data transaction device via at least two communication channels for conveying separately at least two modulated features of at least one light beam modulated with said data and which cooperate to provide timing information such that said light beam is modulated by modifying an intensity and/or color of each pixel within at least one window of the display device and such that all pixels within the at least one window are subjected to identical modification for allowing the data transaction device to display a return code derived from said data on a display unit of the data transaction device,

(c) receiving the return code as input to the client machine by an owner of the data transaction device,

(d) verifying the return code, and

(e) if the return code matches a transaction code associated with the transaction or a predetermined function thereof, proceeding in accordance with the return code.

A data transaction card for use with the invention may be a smart card comprising at least one optical sensor having at least two data communication channels for receiving from an application at least one light beam modulated with said data and which cooperate to provide timing information such that said light beam is modulated by modifying an intensity and/or color of each pixel within at least one window of a display device and such that all pixels within the at least one window are subjected to identical modification, said data informing a user of the smart card of a transaction code associated with the transaction.

Other aspects of the invention will become clearer from the following detailed description of some preferred embodiments thereof.

### BRIEF DESCRIPTION OF THE DRAWINGS

In order to understand the invention and to see how it may be carried out in practice, a preferred embodiment will now be described, by way of non-limiting example only, with reference to the accompanying drawings, in which:

FIG. 1 is a block diagram showing functionally a client-server system for carrying out a secure transaction using a smart card;

FIG. 2 is a block diagram, showing a detail of the smart card;

FIG. 3 shows pictorially an end elevation of a smart card having a pair of optical fibers mounted at an edge thereof;

FIG. 4 shows pictorially the communication between the smart card and a display device associated with a client machine;

FIGS. 5a to 5e are flow diagrams showing the principal operating steps relating to a transaction carried out between the smart card and the client machine;

FIGS. 6a, 6b and 6e are a flow diagram showing the principal operating steps relating to a method for effecting three-channel serial asynchronous communication between the display device and the smart card;

FIGS. 7a to 7e are timing diagrams showing data and sync pulses associated with the communication method depicted in FIGS. 6a, 6b and 6c;

FIGS. 8a, 8b and 8c are a flow diagram showing the principal operating steps relating to a method for effecting two-channel serial asynchronous communication between the display device and the smart card; and

FIGS. 9a, 9b and 9c are timing diagrams showing data and sync pulses associated with the communication method depicted in FIGS. 8a, 8b and 8c.

### DETAILED DESCRIPTION OF THE INVENTION

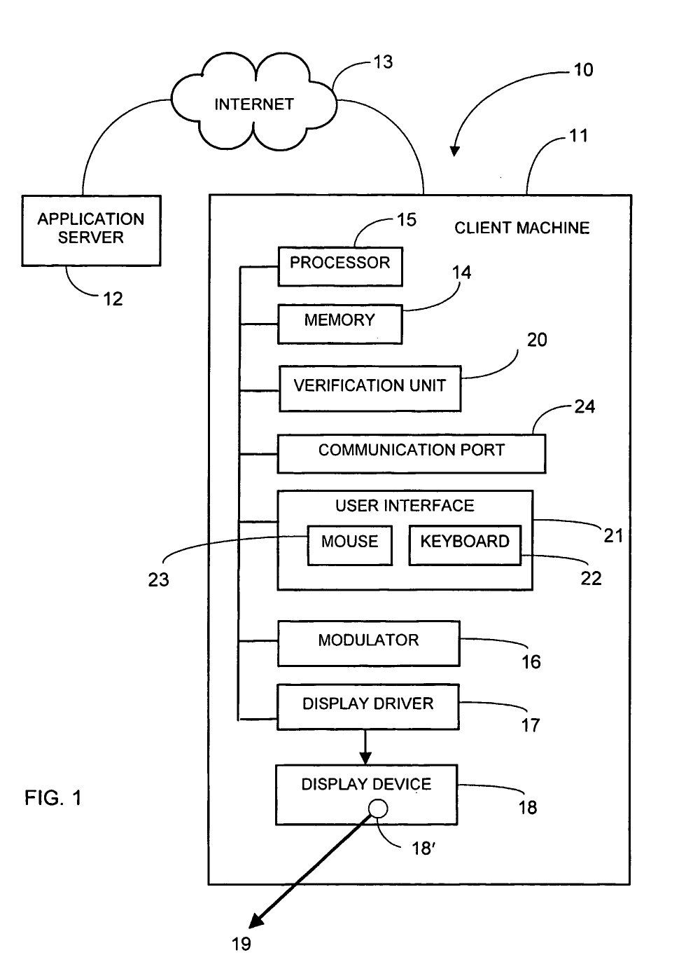

FIG. 1 shows a system depicted generally as 10 comprising a client machine 11 connected to an application server 12 via the Internet 13. The client machine 11 comprises a memory 14 coupled to a transaction processor 15 for processing data stored in the memory. A modulator 16 is coupled to the transaction processor 15 for modulating a signal representative of a light beam with data associated with a transaction code so as to form a modulated light beam signal. A display driver 17 is coupled to the modulator 16 and is responsive to the modulated light beam signal for illuminating a display device 18 so that at least some pixels 18′ thereof emit a light beam 19 that is modulated with the data. A verification unit 20 is coupled to the transaction processor 15 for verifying a return code issued by a user of the data transaction device. A user interface 21, typically including a keyboard 22 and a mouse 23, is coupled to the transaction processor 15 for allowing a user to enter data to the client machine 1.

The transaction processor 15 may be programmed to process the transaction in accordance with the transaction code if the return code matches the transaction code or a function thereof. Alternatively, the client machine 11 merely acts as an intermediary for communicating data to the application server 12 via a communications port 24 and for displaying the results of the transaction including system prompts and the like to a user. The client machine may be a personal computer since this is an increasingly common household product and serves as a vehicle for allowing an owner thereof to carry out a remote transaction executed by the application server 12.

As noted above a problem in carrying out secure client-server transactions via a personal computer is the low security inherent in most such systems. This is because computers are vulnerable to hacking and even nominally secure data can often be intercepted. Security is greatly enhanced by use of a smart card 25 (constituting a data transaction device) but prior use of a smart card has required the provision of a special smart card reader, making it inaccessible to the average user.

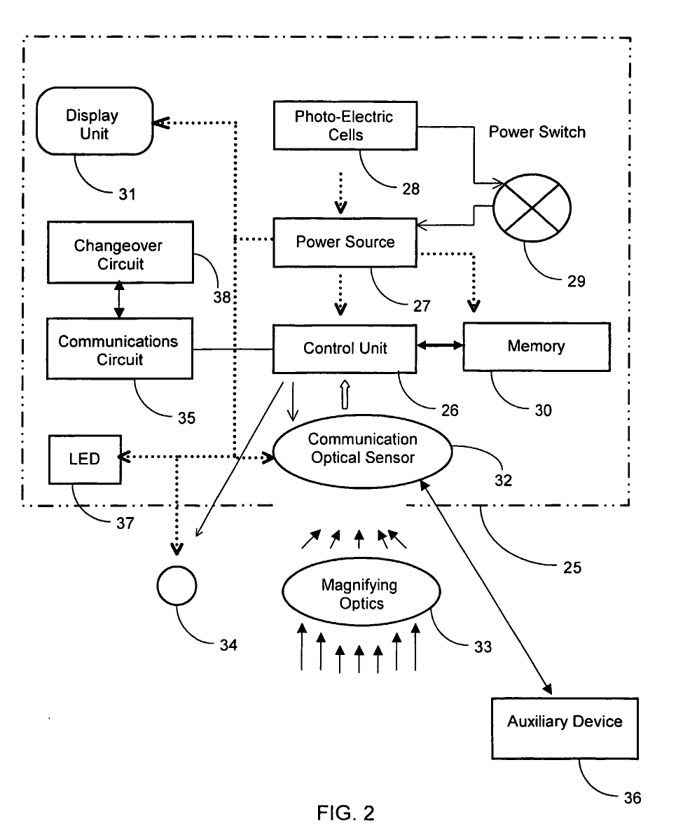

FIG. 2 shows functionally the smart card 25 according to the invention, comprising a control unit 26 powered by a power source 27 such as a battery that is optionally trickle charged or even replaced by an array of photoelectric cells 28. To conserve battery power an on-off switch 29 is provided. A non-volatile memory 30 is coupled to the control unit 26 and stores therein data uniquely identifying the smart card 15. Such data may be a PIN number and may further include application-specific data. For example, if the smart card is to be used in an electronic purse application, the memory 30 may store an available cash credit to be used for purchase of goods, and possible details of the user's charge account to be debited as and when cash is transferred to the smart card. Likewise, the data may user-specific data such as personal information known only to the authorized user. This allows the smart card itself to undergo an initial verification procedure by prompting the user to enter not only the PIN number but also, for example, specified personal details. Such details are stored in the memory 30 of the smart card 25 in such a way as to be accessible only to the control unit 26 and not to the user, so that correct entry thereof when prompted by the control unit constitutes proof that the user is the authorized owner of the smart card. A display unit 31 such as an LCD allows data conveyed by the control unit 26 to be displayed. An optical sensor 32 is coupled to the control unit 26 for sensing light transmitted thereto and being modulated with data for reading by the smart card 25. A magnifying optics 33 may be provided in order to amplify the intensity of the light received by the smart card 25 and conveyed to the control unit 26 thereof.

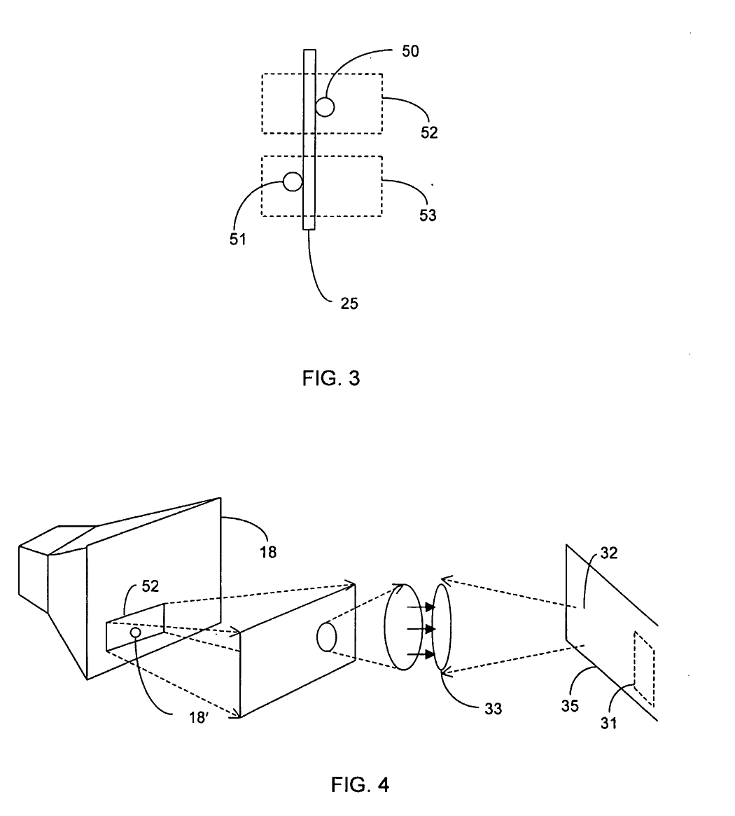

Typically, data is conveyed to the smart card 25 by modulating a signal fed to the display device 18 of the client machine 11 so that at least some of the pixels of the display device 18 emit a modulated light beam that is modulated with the data. The desired modulation can be achieved by modulating the color or the intensity of the light emitted by the pixels. In the case that the display device 18 employs a conventional cathode ray tube (CRT), the modulated light is transmitted to the smart card 25 and is received and amplified by the magnifying optics 33. However, if the display device 18 employs a passive LCD, the light beam is actually reflected from the light-emitting surface of the LCD. To this end, a source of illumination 34 may be provided for illuminating the LCD display device so as to increase the intensity of the modulated light beam reflected thereby. The same technique is also applicable to any other passive display device working on the principle of reflection. Active LCDs are also known, which operate on the principle of light emission and so far as the invention is concerned, these function in the same manner as a CRT or any other active display whose pixels emit light. One or more optical fibers may be coupled to a respective optical sensor 32 for conducting the light beam directly thereto and obviating the need for the magnifying optics 33. This may be achieved as described below with reference to FIG. 3 of the drawings.

An optical communications circuit 35 is coupled to the control circuit 26 for communicating with an auxiliary device 36 using optical communication. By such means, optical communication with the smart card 25 is not confined to the display device 18 of the client machine 11. For example, the auxiliary device 36 may be an infrared communications device that transmits IR data to the optical sensor 32 and receives IR data transmitted thereto by an LED 37 mounted on the smart card 25 and coupled to the control circuit 26 thereof. By default, data is conveyed optically at a fairly low data rate to accommodate the processing that must be performed by the control circuit 26, which must sample the pixels of the display device 18 within an area thereof where the emitted light is modulated with data. In the case where the display device 18 is a CRT, the sampling frequency must exceed the refresh rate of the CRT so as to ensure that at least some samples contain modulated light data. However, when communication takes place with the auxiliary device 36, a higher data rate can be employed and the control circuit 26 must therefore operate in accordance with a different communications protocol.

To this end, the data can be encoded so as to indicate whether IR transmission is employed or not. Alternatively, the LED 37 can attempt to transmit an IR check signal for receipt by the auxiliary device 36, if present. If the IR check signal is received, the receiving device returns an acknowledge signal which indicates that henceforth data communication using IR can be used. In either case, a changeover circuit 38 coupled to the control circuit 26 is responsive to receipt of IR data from the auxiliary device 36 for automatically invoking optical communication at an increased data rate commensurate with IR data communication.

The control unit 26 serves as a processor for processing data received from the client machine 11. Thus, in the case that the data is encrypted by the application server 12, the control unit 26 decrypts the received data and extracts therefrom a return code, which when returned to the application server 12 confirms a transaction to be executed thereby. Alternatively, the control unit 26 transforms the transaction code received from the application server via the client machine according to a transformation function stored within the memory 30 and inaccessible to a user of the smart card. The user is thus prevented from determining the return code, even by intercepting the transaction code fed to the smart card by the client machine and this further ensures that input of the correct return code by the user is proof that the smart card is in his or her possession. On receiving the return code, the application server may perform a reverse transformation of the return code. The result of such reverse transformation should, of course, match the transaction code originally generated by the application server and fed to the smart card (via the client machine). Alternatively, the application server may use the same transformation function to transform the correct transaction code and then verify that the transformed code matches the return code received from the smart card.

FIG. 3 shows pictorially in end elevation a possible configuration of a smart card 25 having a pair of spaced apart optical fibers 50 and 51 mounted at an edge 52 of the smart card 25. Each of the optical fibers 50 and 51 is intended to receive modulated light in a respective transmission window 52 and 53 shown in dotted outline, since they are associated with the display device (not shown) and not with the smart card 25. In use, the smart card 25 is disposed proximate the display device 18 (shown in FIG. 1) with the optical fibers 50 and 51 anywhere in the respective transmission window 52 and 53. The pixels in each of the transmission window 52 and 53 of the display device 18 are modulated with the data to be conveyed to the smart card 25, thus ensuring that regardless of the exact location of the optical fibers 50 and 51 within the transmission window 52 and 53, the optical fibers 50 and 51 overlap pixels that emit modulated light, which is thus conveyed via the optical fibers 50 and 51 to the optical sensor 32.

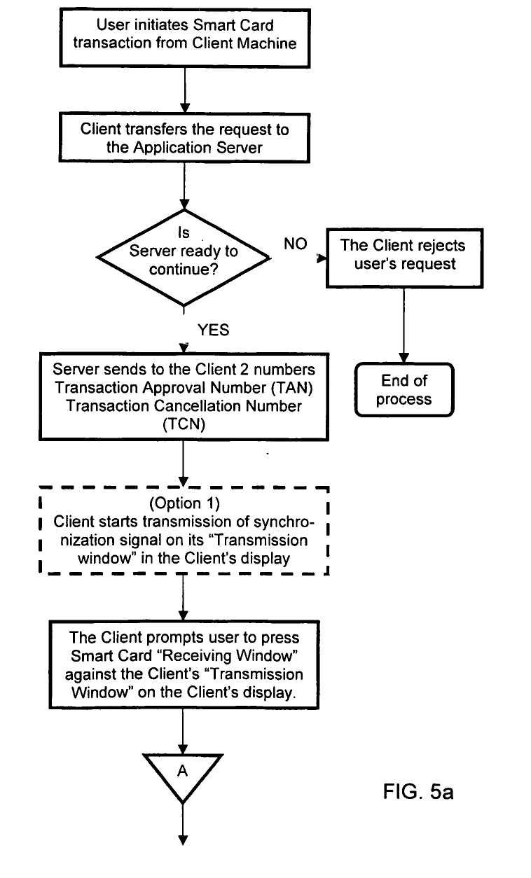

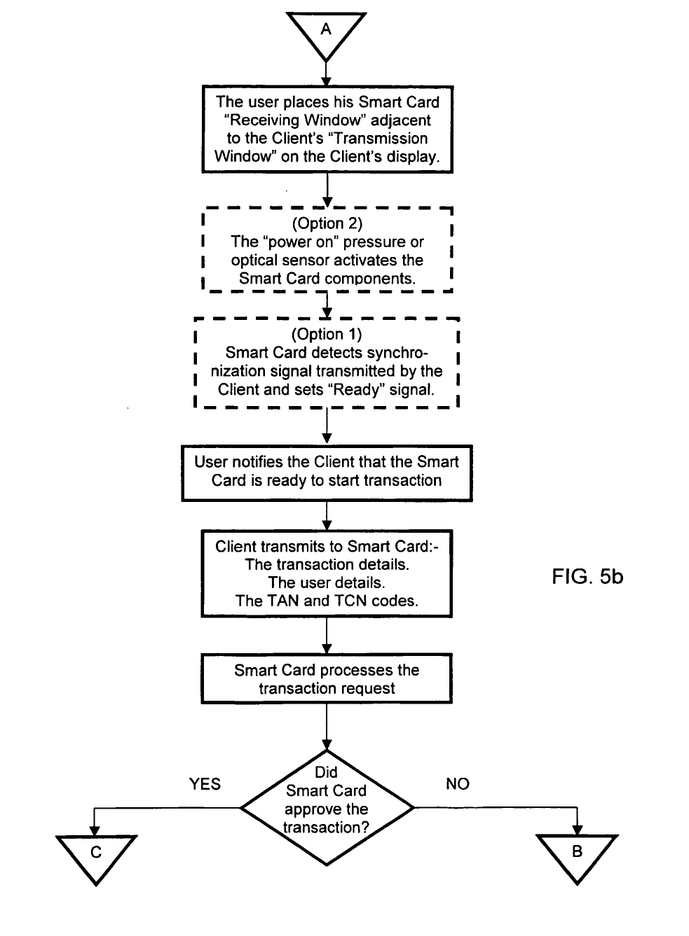

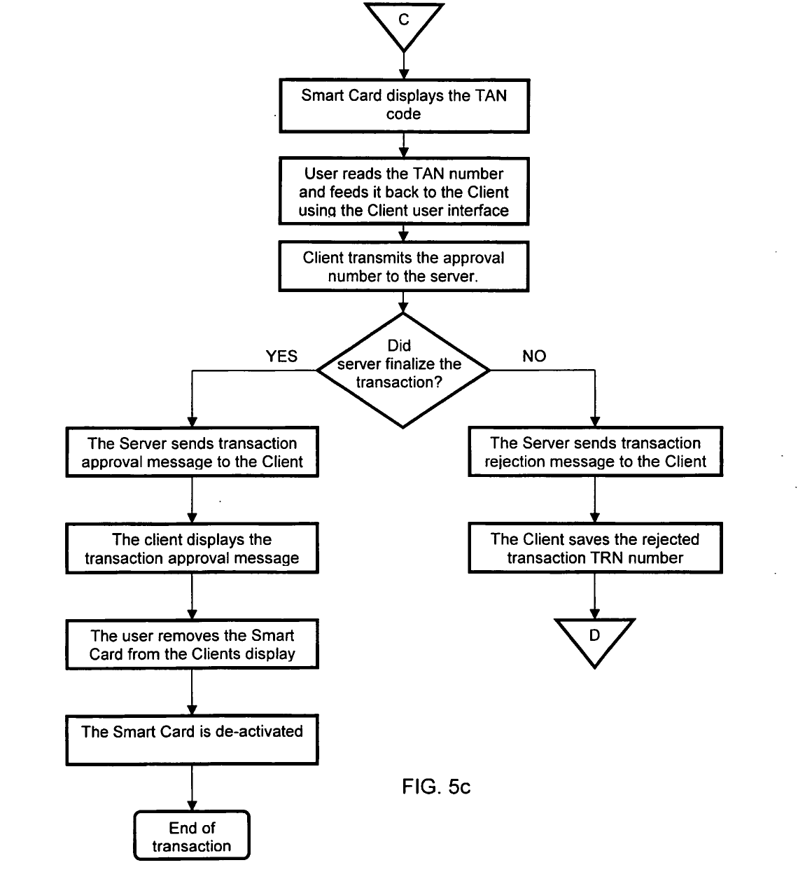

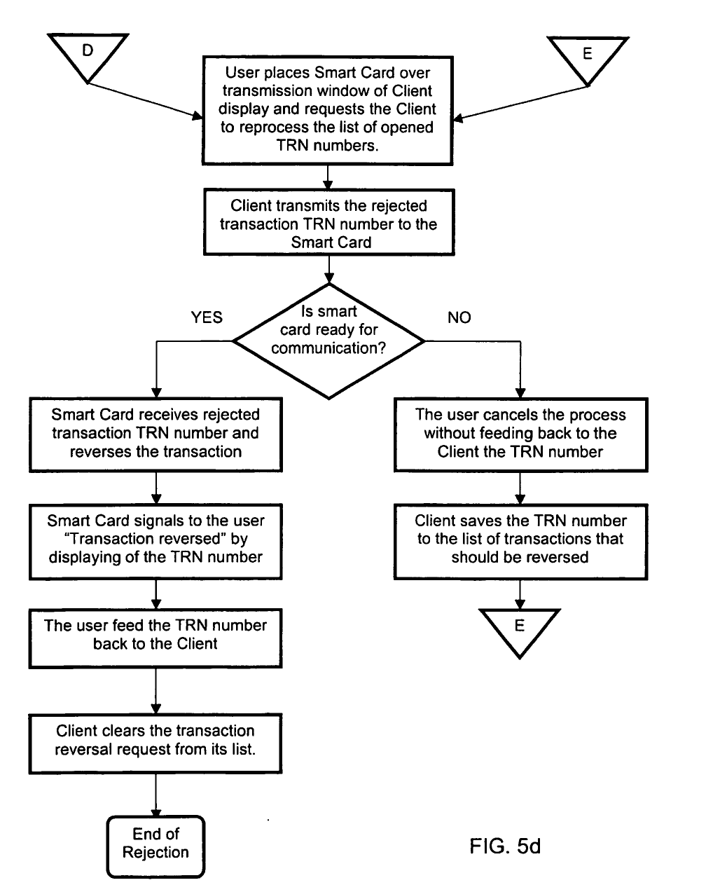

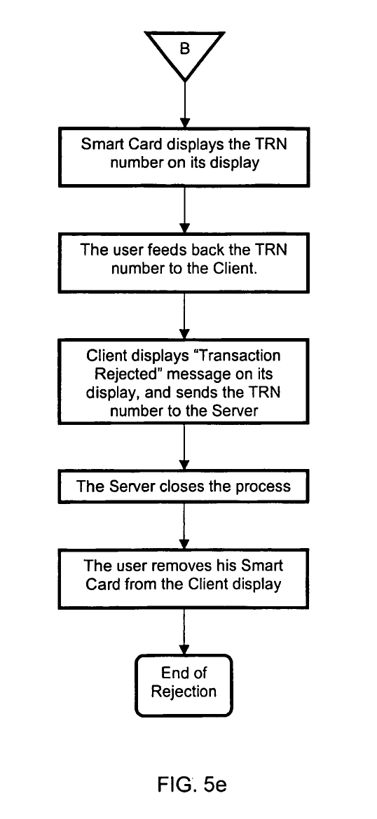

FIGS. 5a to 5e are flow diagrams showing the principal steps carried out by the control unit 26 when used in a typical client-server application. The user enters a request for service and his personal information via the user interface 21 of the client machine 11. The client machine 11 executes a communication algorithm with the application server 12, either via the Internet in the case that the client machine 11 is remotely coupled to the application server 12 via the Internet 13. However, the invention also contemplates a standalone application, which is entirely performed by the client machine, such as an arcade game where the smart card 25 is used as an electronic purse for effecting payment. In either case, the client machine 11 receives from the application server or derives a “Transaction Authorization” code to be returned in case the client machine 11 completes the transaction with the smart card 25 successfully and optionally a “Transaction Cancellation” code to be used to reverse the transaction. Both the “Transaction Authorization” and the “Transaction Cancellation” codes constitute transaction codes that may be returned by the smart card 25 to the client machine 11 to inform the client machine 11 how to proceed. Thus, transaction authorization and cancellation are themselves transactions that are carried out by the application server on receipt of appropriate transaction codes from the smart card 25. These codes are preferably encrypted to enhance security and prevent unauthorized access thereto.

The client machine 11 signals to the user that it is ready to start the transaction. Optionally it displays a rectangular boundary on the display device 18 constituting a “Transmission Window” 40 indicating where the user should place the smart card 25. It prompts the user to inform the client machine 11 when it is ready by sending a “Start” signal which can input by means of any of the input devices constituting the user interface 21, such as the keyboard 22, the mouse 23 or via a touch pad, microphone or any other suitable input device.

The user places the smart card 25 with the optical sensor 32 facing the display device 18 of the client machine 11 within the “Transmission Window” 40. A communication-synchronization process may be applied between the client machine 11 and the smart card 25 as explained above. In either case, when the user is ready he sends the “Start” signal using one of the input devices of the client machine 11, usually the keyboard 22. The client machine 11 sends continuously a synchronization sequence that the smart card 25 should detect. Once detected, the smart card displays a “Synchronized” sign on the display unit 31 or via the LED. 37 or any other suitable indication means. The user then depresses a “Start Processing” button within the user interface 21 of the client machine 11 to start communication process. It may be proved to be sufficiently practical to dispense with the initial synchronization whereby after aligning the smart card 25 with the transmission window 40 on the display device 18, the user depresses the “Start Processing” key on the interface 21 of the client machine 11. The “Start Processing” key can be any input device for providing an input signal to the client machine 11. If this scenario proves to be practical, then the synchronization of the communication between the smart card 25 and the client machine 11 will be the initial change of state of the illumination spot on the “Transmission Window” 40 in the display device 18.

The client machine 11 communicates with the smart card 25 so as to receive therefrom the user's personal data stored in the memory 30 thereof. It also transfers to the smart card 25 the requested transaction details and the return code received from the Smart Card Server (or generated locally in case the specific implementation does not require a such server), the information typically being encrypted to increase security. The Smart Card 25 receives the information and the control unit 26 processes the received data in order to determine whether or not to allow the transaction. In case of a positive decision the smart card displays the “Transaction Authorization” code on its display unit 31, otherwise it may display a rejection message or explanation for the rejection and conceal the “Transaction Authorization” code from the user. The user can accept the transaction by inputting the “Transaction Authorization” code to the client machine 11. Alternatively, he can reject the transaction by entering the “cancellation code” to the client machine 11. It should be noted that since, in either case, the return code sent by the user is revealed by the display unit 31 of the smart card 25, receipt of a valid return code by the application server 12 serves as a very good indication that the smart card 25 is in the possession of the user and renders the system very secure.

The security of the transaction may be even further increased by both the smart card 25 and the application server 12 employing an algorithm to transform the input “Transaction Authorization” code to a different “Returned Transaction Authorization” code. By such means, even if someone successfully intercepts the transaction code sent by the application server to the client machine, he will not be able to derive the correct return code.

If the user feeds the “Transaction Authorization” code or its related “Return Transaction Authorization” code back to the client machine 11, the client machine 11 displays or signals an “End of Transaction” message and the user may then remove his card 25 from the display device 18. The client machine transmits the transaction details back to the application server 12 with the “Transaction Authorization” code to complete the transaction authorization cycle. If the user feeds back a cancel or reject signal, then the client machine 11 clears the transaction details from the smart card 25 and then instructs the user to remove his card.

In case the user requests to cancel the transaction, the client machine 11 requests the appropriate cancellation code from the application server 12. The application server 12 sends a cancel transaction message, which contains the “Transaction Cancellation” code corresponding to the required transaction. The client machine 11 transfers the code to the smart card 25, whose control unit 26 checks whether the requested transaction is stored in the memory 30 thereof and, if so, erases it or renders it otherwise disregarded.

Reference has already been made above to the difficulties in effecting serial asynchronous communication between the display device and the smart card and to the various factors that make such communication difficult.

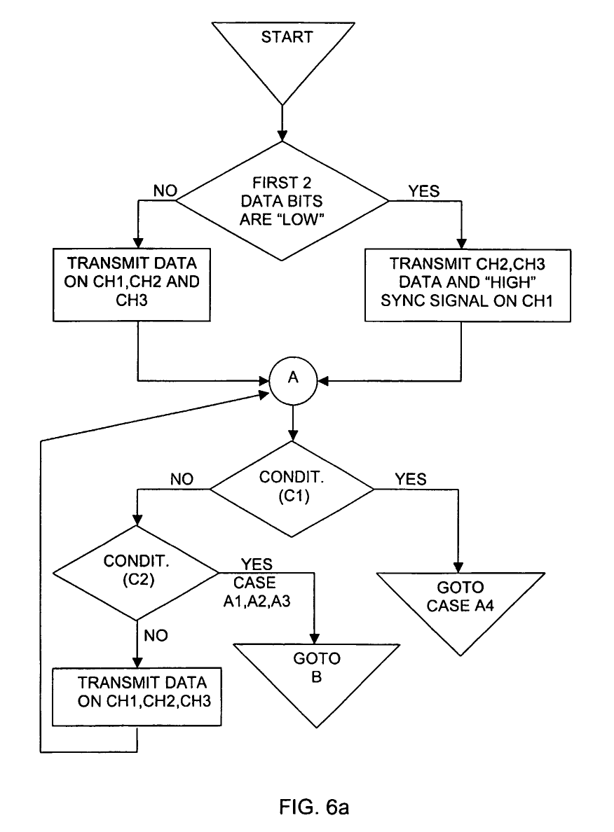

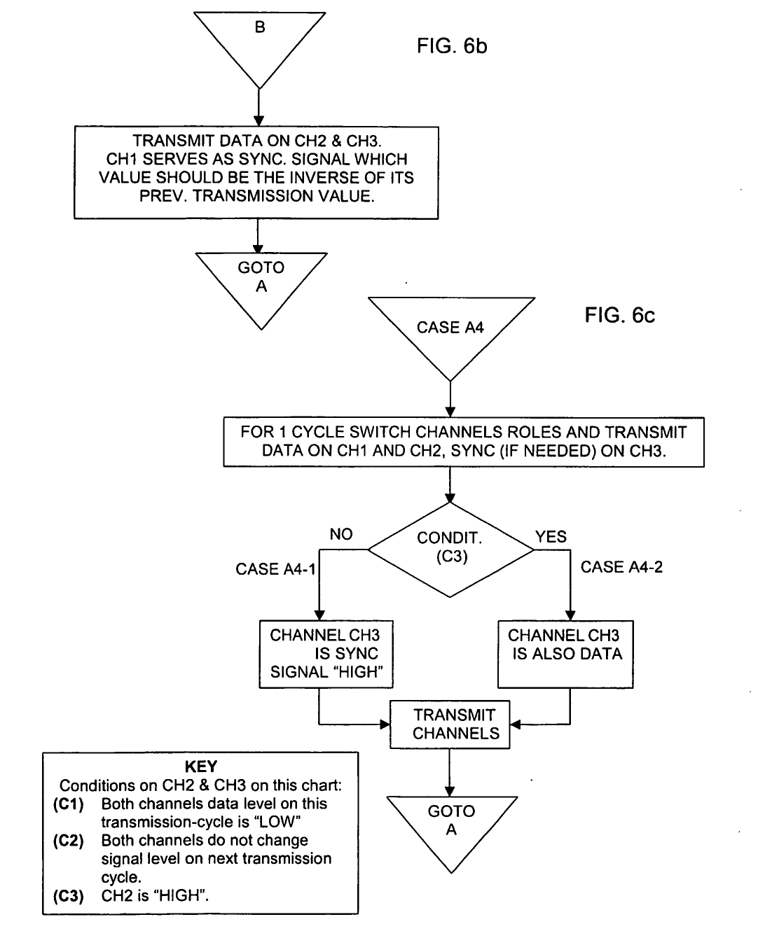

FIGS. 6a, 6b and 6c are a flow showing the principal operating steps relating to a method for effecting three-channel serial asynchronous communication between the display device and the smart card. Such a method is particularly suited for use with a color monitor where each pixel is a triad having three different colored light sources, each of which can be independently modulated with data. Alternatively, the pixels may be spatially separated so that pixels from different points within the transmission window of the smart card carry modulated data and sync signals. In either case, as noted above, to transmit and receive data asynchronously the data must be clocked and the sync pulse as well as the data pulse must be modulated on to separate light beams. However, it is essential to differentiate between different pulses so as to avoid the ambiguity that can arise owing to variations in the refresh frequencies of different display devices and the problems of overlap whereby a pixel that apparently indicates a new data pulse having the same level as the previous pixel may nevertheless be the same data pulse. To this end, communication is based on more than one communication channel, using multiple color or multiple spots on the display or both. The communications protocol does not allow a situation where data on all channels is “0”, and at least one channel should show a “1” state pulse. The communications protocol requires a change of state in at least in one communication channel to indicate new data. The smart card contains a demodulator that samples the ‘channels’ states for new data each time it detects a change of pulse state in at least one channel relative to its current state.

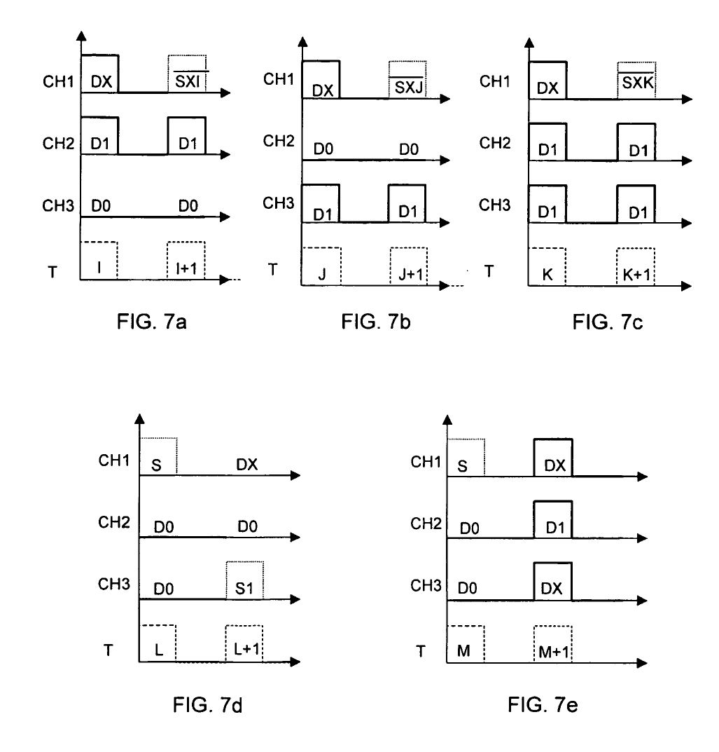

The above principles apply regardless of the number of channels that are used to convey data (including the sync signal, which may be extracted out of the data itself or when the data does not adhere to the requirements of an embedded sync signal such a signal must be inserted and carried on one of the data channels). However, the actual implementation varies according to the number of channels that are used Thus, serial communication using three channels will now be explained with reference to the flow diagram shown in FIGS. 6a to 6c, and the corresponding timing diagrams shown in FIGS. 7a to 7e.

The timing diagrams shown in FIGS. 7a to 7e relate to transmission on three channels, and detail the five special cases in the transmission protocol where non-data synchronization signals must be inserted in order to keep the protocol requirement of at least one clock signal and at least one signal state transition. In these five special cases, one of the channels is dedicated to synchronization. When no special synchronization signals need to be generated, all three channels may be used for data transmission.

In the timing diagrams of FIGS. 7a to 7e, the signal name is composed of two or three characters as shown in Table 1 below:

TABLE 1
Nomenclature

| | | | |
|---|---|---|---|
| First character | signal type | D | Data signal |
| | | S | Synchronization signal |
| Second character | signal level | 0 | LOW |
| | | 1 | HIGH |
| | | X | LOW or HIGH |

| | | |
|---|---|---|
| Third character | Time ID | I or J or K or L. |

A signal can be marked with a bar to denote its complement value. Bold signals are data and dotted signals are synchronization signals. In FIG. 6a, reference to Cases A1, A2, A3 and A4 refer to the timing diagrams shown in FIGS. 7a, 7b, 7c and to two special cases shown in FIGS. 7d and 7e and which are denoted Case A4-1 and Case A4-2 in FIG. 6c. The logic of the timing diagrams is consistent throughout the different cases and so it will suffice to explain just one of these cases. In FIG. 7a, the first cycle is denoted “I” and the successive cycle is denoted “I+1”. In cycle “I”, the signals on channels 1, 2 and 3 are respectively “X”, “1” and “0”. That is to say (with reference to Table 1 above), the signal level on channel 1 is irrelevant; on channel 2 it is HGH and on channel 3 it is LOW. In the next cycle “I+1”, the signals on channels 1, 2 and 3 are respectively “X”, “1” and “0”. That is to say, the signal levels on channels 2 and 3 remain HIGH and LOW, respectively, there being no change. So channel 1 is used as the clock signal by inverting its level. Thus, if it were at logic “1” in the previous cycle “I”, it now becomes logic “0” and vice versa. The modulator within the display driver buffers at least one cycle of data on the three channels so that the corresponding signals on the successive cycle can be compared and appropriate action taken, if necessary, to assign one of the channels as the clock signal. Likewise, the demodulator in the smart card is adapted to extract a clock signal from any one of the independent light beams being modulated with a first logic level, read respective signals modulated on each of the light beams, and compare for each signal a current logic level and a previous logic level and accept the signals as new data if and only if in respect of at least one of the signals the current logic level and the previous logic level are different.

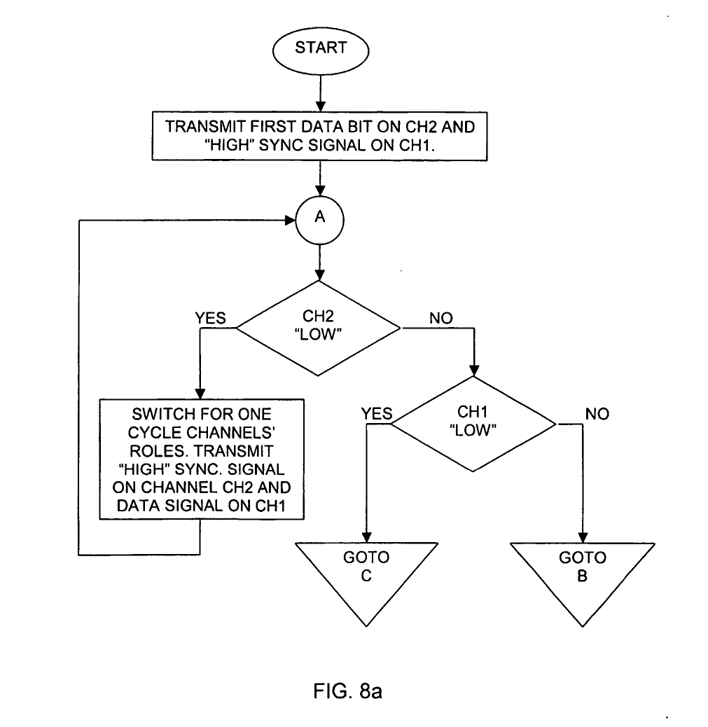

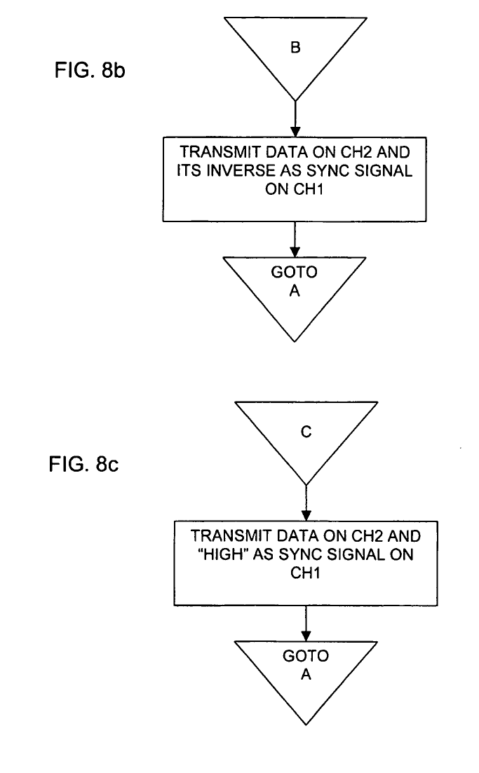

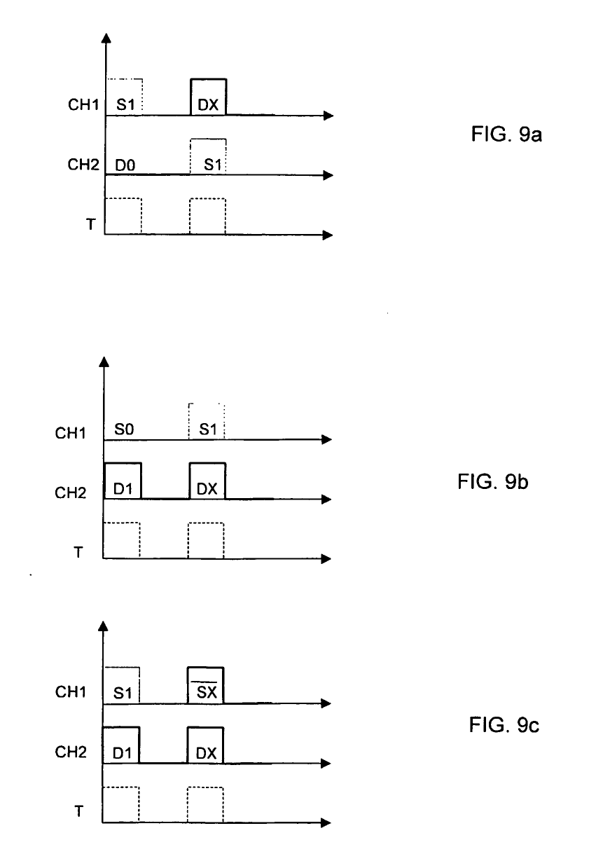

It is also possible to use only two pixels to convey data, thus allowing the above-described algorithm to be generalized also for use with monochrome displays, where spatially separated pixels must be used to convey modulated light beams to respective optical sensors of the smart card. Such a two-channel protocol will now be described with reference to the flow diagram shown in FIGS. 8a to 8c, and the corresponding timing diagrams shown in FIGS. 9a to 9c.

In the timing diagrams of FIGS. 8a to 8c, the signal name is composed of two characters as shown in Table 2 below:

TABLE 2
Nomenclature

| | | | |
|---|---|---|---|
| First character | signal type | D | Data signal |
| | | S | Synchronization signal |
| Second character | signal level | 0 | LOW |
| | | 1 | HIGH |
| | | X | LOW or HIGH |

It will be noted from the timing diagrams of FIGS. 8a to 8c that there exist three possible situations that must be considered by the transmission protocol. At any given point one channel is used for synchronization and the other is used for data transfer.

A signal can be marked with a bar to denote its complement value. SX is the complement of DX in the same cycle. Bold signals are data and dotted signals are synchronization signals. Thus, at the start of the transmission, a HIGH sync signal is transmitted on the first channel and the first data bit is transmitted on the second channel. If, during successive samples, the signal on channel two is LOW, then the roles of the two channels are switched for one cycle. That is, a HIGH sync signal is transmitted on the second channel and the data bit is transmitted on the first channel. Otherwise, where the signal on channel two is HIGH, if the signal on channel one is HIGH, then the data signal is transmitted on the second channel and its inverse (or complement) is transmitted on the first channel. Likewise, if the signal on channel two is HIGH, and the signal on channel one is LOW, then the data signal is transmitted on the second channel and a HIGH level signal is transmitted on the first channel and serves as the sync signal.

It will be appreciated that modifications may be made to the preferred embodiments, without departing from the inventive concept. For example, in order to increase the communication rate (if needed), a plurality of “Transmission Windows” can be provided on the display device 18 of the client machine 11 and a like plurality photoelectric sensors can be provided on the smart card 25 to operate in parallel. In order to reduce costs and use a single photo-sensor (optionally with multiple cells). A set of optical fibers can be stretched in the card from the sensor to conduct the light from spatially displaced several input points on the card back to the photo-sensor device. The input from the fiber-optics lines can be read either in parallel via multiple cells in the sensor, or serially via a single cell sensor.

It will also be understood that the client machine 11 may be a suitably programmed computer. Likewise, the invention contemplates a computer program being readable by a computer for executing the method of the invention. The invention further contemplates a machine-readable memory tangibly embodying a program of instructions executable by the machine for executing the method of the invention.

The system according to the invention may be used in a large number of different applications. For example, the smart card can be an electronic purse allowing the user to prepay and charge his Smart Card with a limited amount of money and to recharge the credit using a home computer. Furthermore, such an electronic purse can be used for purchasing over the Internet using the home PC with no additional interfacing device.

The invention also allows secured use of credit cards over the Internet. One of the problems of using credit cards over the Internet in hitherto-known systems is the difficulty of the application server in unequivocally verifying the user, owing to the danger that the client performing the transaction has acquired the credit cards details and does not actually have the card in his possession. This drawback is overcome by the invention owing to the fact that the smart card serves as an essential component in the verification loop by acting as the medium for conveying the transaction code to the user.

An extension of the electronic purse allows the smart card to be used as a Virtual Ticket purse, allowing the user to buy a wide range of tickets such as parking tickets, movie tickets, and tickets for sports events etc. using his home PC and the Internet. The transaction is recorded in the virtual ticket purse, saving the user the need to go and buy the ticket personally. When the user wishes to use the ticket, he initiates a usage transaction with an on-site client machine, which verifies that the smart card purchased the requested ticket and, if authorized, displays on the smart card display the ticket code to be used.

It will also be appreciated that, whilst the preferred embodiment uses IR communication to effect bi-directional data communication with the auxiliary device, any other suitable form of optical communication may be employed. So far as data communication from the auxiliary device to the smart card is concerned, the principle of communication is unchanged, assuming that the optical sensor has sufficient bandwidth to sense light of the relevant frequency. With regard to data communication in the reverse direction is concerned, here too the principle of operation is unchanged, the only requirement being that the LED emits light of a frequency that can be sensed by the complementary optical sensor in the auxiliary device.

It will also be appreciated that use of the invention does not preclude conventional use of the smart card using a standard contact field. In such case, an automatic changeover circuit may be provided for automatically disabling communication via the contact field when light is received by the optical sensor. This allows the user to use the same smart card both with ATM machines having contacts and also with display devices some of whose pixels are modulated with data to be conveyed optically. Likewise, contactless communication using a coil antenna within the smart card may also be provided. In such case both contact communication and optical communication can be automatically disabled on detecting an induced voltage across the antenna coil. Furthermore, a piezoelectric element can be provided on the smart card to provide an audio feedback signal to the client machine. To this end, the user interface in the client machine may include a microphone to pickup the audio feedback signal.

Finally, while the invention has been described with particular regard to use of a personal computer having a display, it will be understood that the invention is equally well applicable for use with any suitable client machine or application server. For example, the invention is equally well applicable to use of hand-held terminals, WEB TV or even cellular telephones to communicate with the Smart Card without the need for additional hardware interfacing equipment. In all cases the application server and the supplier can verify that the client does possess the smart card at the time the transaction takes place, and it is also possible to record the transaction code in the memory of the smart card for future proof. Furthermore, while the invention has been described with particular regard to use of a smart card having an optical sensor, it will be understood that any suitable data transaction device having an optical sensor may be employed. Thus, for example, a cellular telephone having an optical sensor, a display and processor may be used, as may a suitably modified hand-held computer or other equivalent device.

In the method claims that follow, alphabetic characters used to designate claim steps are provided for convenience only and do not imply any particular order of performing the steps.

1. A method for communicating data to a data transaction device having an optical sensor, the method comprising the steps of:
(a) displaying on a predetermined window of a display device a modulated light beam that is modulated with said data, and
(b) placing an identifiable area of the data transaction device containing the optical sensor against the predetermined window of the display device so that the optical sensor receives the modulated light beam.

2. The method according to claim 1, further including the step of:
(c) interposing a magnifying optics between said identifiable area of the data transaction device and the predetermined window of the display device for concentrating light from multiple display pixels within the predetermined window of the display device on to the optical sensor of the data transaction device.

3. The method according to claim 1 or 2, for use with a raster display device further including the step of:
(d) sampling light samples of the modulated light beam at a rate exceeding the refresh rate of the raster display device so that at least some of the light samples are modulated with said data.

4. The method according to claim 1 or 2, for use with a passive display device further including the step of:
(e) providing a source of illumination in association with the data transaction device for illuminating the passive display device so as to increase the intensity of the modulated light beam reflected thereby.

5. The method according to claim 1 or 2, wherein the display device is a LCD display.

6. The method according to any one of claims 1 to 5, further including the step of:
(f) providing at least two optical sensors each within a respective identifiable area of the data transaction device for communicating with pixels in a respective window of the display device.

7. The method according to any one of claims 1 to 6, further including the step of:
(g) conducting light from at least some of said pixels to at least one of the optical sensors using an optical fiber.

8. The method according to any one of claims 1 to 7, further including:
(h) communicating between the data transaction device and an auxiliary optical communication device via the optical sensor and an illumination source in the data transaction device.

9. The method according to any one of claims 1 to 8, wherein step (a) includes:
i) modulating respective independent light beams from spatially separated pixels of the display and/or from different colored light beams so as to allow respective optical sensors in the data transaction card to receive respective signals from the respective light beams,
ii) ensuring that at least one of the independent light beams is modulated with a first logic level serving a clock signal, and
iii) ensuring that a current logic level and a previous logic level of at least one of said signals are different.

10. The method according to any one of claims 1 to 8, wherein step (b) includes:
i) placing an identifiable area of the data transaction device containing at least two optical sensors each for receiving a respective independent light beam from spatially separated pixels of the display and/or from different colored light beams against the predetermined window of the display device so that the optical sensors receive respective signals modulated on the respective light beams,
ii) extracting a clock signal from any one of the independent light beams being modulated with a first logic level,
iii) reading respective signals modulated on each of the light beams,
iv) comparing for each signal a current logic level and a previous logic level and accepting said signals as new data if and only if in respect of at least one of said signals the current logic level and the previous logic level are different.

11. The method according to any one of claims 1 to 8, wherein the display device is a color device having a matrix of pixels for producing first, second and third colored light beams, and step (b) includes:
i) placing an identifiable area of the data transaction device containing three optical sensors each for receiving a respective one of the first, second and third colored light beams against the predetermined window of the display device so that the three optical sensors receive respective signals from the modulated colored light beams.

12. A method for carrying out a secure transaction between a data transaction device and a client machine coupled to a display device, including the following steps all carried out by the data transaction device or an owner thereof:
(a) inputting a request for service to the client machine,
(b) receiving data from the client machine and conveying transaction data representative thereof to an optical sensor of the data transaction device as a modulated light beam via the display device, and
(c) displaying a transaction code representative of the transaction data on a display unit of the data transaction device.

13. The method according to claim 12, further including:
(d) authorizing the transaction by inputting the transaction code using a user interface coupled to the client machine.

14. The method according to claim 12, further including
(e) canceling the transaction by inputting the transaction code using a user interface coupled to the client machine.

15. The method according to claim 12 or 14, wherein step (b) includes:
i) placing of the data transaction device containing the optical sensor against so that the optical sensor receives the modulated light beam.

16. The method according to any one of claims 12 to 15, further including:
(f) receiving from the client machine a termination signal that is conveyed to an optical sensor of the data transaction device as a modulated light beam via the display device,
(g) displaying a termination message on a display unit of the data transaction device, and
(h) removing the data transaction device.

17. The method according to any one of claims 12 to 16, further including:
(i) processing the data received from the client machine for deriving therefrom the transaction data.

18. The method according to claim 17, wherein the step of processing includes decrypting the data received from the client machine.

19. The method according to any one of claims 12 to 18, wherein the data received from the client machine includes data uniquely identifying the data transaction device.

20. The method according to any one of claims 12 to 19, wherein the transaction code is determined in synchronism by both the data transaction device and the client machine or by an application server connected thereto thus rendering it unpredictable.

21. The method according to claim 20, further including:
(j) transforming the transaction code received by the data transaction device with a transformation function that is inaccessible to a user of the transaction code so as to generate a return code, and
(k) displaying the return code for inputting to the client machine in order to continue with the transaction.

22. The method according to according to any one of claims 12 to 21, including the steps of:
(l) initiating communication between the data transaction device and an auxiliary optical communication device at an initial data rate,
(m) receiving an indication that said communication between the data transaction device and the auxiliary optical communication device is taking place, and
(n) automatically invoking communication between the data transaction device and the auxiliary optical communication device at a speed that is higher than said initial data rate;
thus allowing the data transaction device to communicate interchangeably with said display device or with the auxiliary optical communication device.

23. A method for carrying out a secure transaction between a data transaction device a client machine, including the following steps all carried out by the client machine:
(a) receiving a request for service,
(b) conveying data to an optical sensor of the data transaction device as a modulated light beam via a display device of the client machine for allowing the data transaction device to display a return code derived from said data on a display unit of the data transaction device,
(c) receiving the return code as input to the client machine by an owner of the data transaction device,
(d) verifying the return code, and
(e) if the return code matches a transaction code associated with the transaction or a predetermined function thereof, proceeding in accordance with the return code.

24. The method according to claim 23, wherein the return code is an authorization code and step (e) includes carrying out the transaction.

25. The method according to claim 23, wherein the return code is a cancellation code step (e) includes canceling a transaction.

26. The method according to any one of claims 23 to 25, further including:
(f) conveying via the display device of the client machine a termination signal to the optical sensor of the data transaction device as a modulated light beam for informing an owner of the data transaction device that the transaction is complete.

27. The method according to any one of claims 23 to 26, further including:
(g) conveying data relating to the transaction to an application server coupled to the client machine for carrying out the transaction,
(h) receiving return transaction data from the application server, and
(i) sending the return code to the application server for verification thereby.

28. The method according to any one of claims 23 to 27, further including:
(o) using the transaction data to encrypt the data prior to sending to the data transaction device.

29. The method according to claim 27, wherein the data is encrypted by the server prior to sending to the client machine.

30. A data transaction device comprising:
at least one optical sensor for receiving from an application at least one light beam modulated with data that informs a user of the data transaction device of a transaction code or a function thereof associated with the transaction.

31. The data transaction device according to claim 30, further including:
a magnifying optics for concentrating the at least one light beam on to the at least one optical sensor.

32. The data transaction device according to claim 30 or 31, further including:
a sampling unit for sampling light samples of the at least one modulated light beam at a rate exceeding the refresh rate of a raster display device emitting the light beam so that at least some of the light samples are modulated with said data.

33. The data transaction device according to claim 30 or 31, further including:
a source of illumination that may be used for illuminating a passive display device so as to increase the intensity of the modulated light beam reflected thereby.

34. The data transaction device according to any one of claims 32 to 33, further including:
at least one optical fiber for conducting to the at least one optical sensor a respective modulated light beam associated with at least one pixel in a corresponding transmission window of the display device.

35. The data transaction device according to any one of claims 30 to 34, further including:
an optical communications circuit for communicating with an auxiliary device using optical communication.

36. The data transaction device according to claim 35, including:
a changeover circuit that is responsive to an initiation of said optical communication between the data transaction device and the auxiliary device for automatically invoking said optical communication at an increased data rate.

37. The data transaction device according to claim 36, wherein the optical communications circuit includes an illumination source for conveying data to the auxiliary device.

38. The data transaction device according to any one of claims 30 to 37, further including a display unit for displaying a message.

39. The data transaction device according to any one of claims 30 to 38, further including a processor for processing the data received from the client machine so as to derive therefrom the transaction data.

40. The data transaction device according to claim 39, wherein the processor receives the transaction code from the client machine and transforms the transaction code to generate a return code so that the transaction code remains concealed to the user.

41. The data transaction device according to any one of claims 30 to 40, further including a mode selector switch for selecting different modes of communication so as to allow the data transaction device to be used with non-optical communication devices.

42. The data transaction device according to claim 41, wherein the mode selector switch is responsive to data received by the optical sensor for automatically selecting an optical communication mode.

43. The data transaction device according to any one of claims 30 to 42, being a smart card.

44. The data transaction device according to any one of claims 30 to 43, including:
respective optical sensors for receiving respective modulated independent light beams from spatially separated pixels of the display and/or from different colored light beams, and
a demodulator that is coupled to the optical sensors and is configured to:
i) extract a clock signal from any one of the independent light beams being modulated with a first logic level,
ii) read respective signals modulated on each of the light beams,
iii) compare for each signal a current logic level and a previous logic level and accept said signals as new data if and only if in respect of at least one of said signals the current logic level and the previous logic level are different.

45. A client machine for carrying out a secure transaction with a data transaction device, the client machine comprising:
an input port for receiving a request for service,
a modulator for modulating a signal representative of a light beam with data associated with a transaction code so as to form a modulated light beam signal, and
a display driver coupled to the modulator and responsive to the modulated light beam signal for illuminating a display device so that at least some pixels thereof emit a light beam that is modulated with the data.

46. The client machine according to claim 45, further including:
a verification unit for verifying a return code issued by a user of the data transaction device, and
a transaction processor coupled to the verification unit for processing the transaction in accordance with the transaction code if the return code matches the transaction code or a function thereof.

47. The client machine according to claim 45, further including:
a communications port for coupling to an application server and for conveying thereto data relating to the transaction for enabling the application server to carry out the transaction, for receiving return transaction data from the application server, and for sending a return code to the application server for verification thereby.

48. The client machine according to any one of claims 45 to 47, wherein the modulator is adapted to modulate the light beam signal with a termination signal, which is used to inform an owner of the data transaction device that the transaction is complete.

49. The client machine according to any one of claims 45 to 47, wherein the modulator is adapted to:
i) modulate respective independent light beams from spatially separated pixels of the display and/or from different colored light beams so as to allow respective optical sensors in the data transaction card to receive respective signals from the respective light beams,
ii) ensure that at least one of the independent light beams is modulated with a first logic level serving a clock signal, and
iii) ensure that a current logic level and a previous logic level of at least one of said signals are different.

50. A computer program comprising computer program code means for performing all the steps of any one of claims 1 to 11 when said program is run on a computer.

51. A computer program as claimed in claim 51 embodied on a computer readable medium.

52. A computer program comprising computer program code means for performing all the steps of any of claims 12 to 22 when said program is run on a computer.

53. A computer program as claimed in claim 53 embodied on a computer readable medium.

54. A computer program comprising computer program code means for performing all the steps of any of claims 23 to 29 when said program is run on a computer.

55. A computer program as claimed in claim 55 embodied on a computer readable medium.

56. A system for carrying out a secure transaction between a data transaction device and a client machine,
the data transaction device comprising at least one optical sensor for receiving from an application a light beam modulated with data that informs a user of the data transaction device of a return code for sending to the client machine in order to complete the transaction, and
the client machine comprising:
a modulator for modulating a signal representative of a light beam with data associated with a transaction code so as to form a modulated light beam signal,
a display driver coupled to the modulator and responsive to the modulated light beam signal for illuminating a display device so that at least some pixels thereof emit a light beam that is modulated with the data,
a verification unit for verifying a return code issued by a user of the data transaction device, and
a transaction processor coupled to the verification unit for processing the transaction in accordance with the transaction code if the return code matches the transaction code or a function thereof.

57. The system according to claim 56, further including an application server coupled to a communications port of the client machine for receiving from the client machine data relating to the transaction for enabling the application server to carry out the transaction, and for returning transaction data to the client machine.

58. The system according to claim 57, wherein the client machine is integral with the application server.
